(19) United States
(12) Patent Application Publication
(10) Pub. No.: US 2023/0160236 A1
(43) Pub. Date: May 25, 2023

(54) SECURITY APPARATUS FOR PORTABLE ELECTRONIC DEVICE

(71) Applicant: ACCO Brands Corporation, Lake Zurich, IL (US)

(72) Inventors: Alex J. Klinkman, Campbell, CA (US); Erica Serna, San Mateo, CA (US); Michael D. Otsuka, Sunnyvale, CA (US); Wilson S. Tse, Burnaby (CA); James Kao, Fremont, CA (US)

(21) Appl. No.: 18/056,418

(22) Filed: Nov. 17, 2022

Related U.S. Application Data
(60) Provisional application No. 63/281,311, filed on Nov. 19, 2021.

(51) Int. Cl. E05B 73/00

(52) U.S. Cl. CPC E05B 73/0082

(57) ABSTRACT

A security apparatus for a portable electronic device includes a lock mechanism. A lock cylinder is configured to be rotated by a key. A cam member is coupled to the lock cylinder for rotation with the lock cylinder between an engaged position and a disengaged position. A first finger and a second finger are configured to be inserted into an aperture of the portable electronic device. The plunger is positioned between the first finger and the second finger. A user input member coupled to the plunger is selectively actuatable to move the plunger relative to the first and second fingers. When the cam member is in the engaged position, the user input member is precluded from moving from a first position to a second position. When the cam member is in the disengaged position, the user input member is capable of moving from the first position to the second position.

### CROSS-REFERENCE TO RELATED APPLICATIONS

The present application claims the benefit of U.S. Provisional Patent Application No. 63/281,311, filed Nov. 19, 2021, the entire contents of which are incorporated herein by reference.

### FIELD OF THE INVENTION

The present invention relates to security apparatuses for portable electronic devices, such as laptop computers, tablet computers, smartphones, and other mobile devices.

### SUMMARY

In one embodiment, the invention provides a security apparatus for a portable electronic device having an aperture. The security apparatus includes a lock mechanism having a lock cylinder and a cam member. The lock cylinder is configured to be rotated by a key. The cam member is coupled to the lock cylinder for rotation with the lock cylinder between an engaged position and a disengaged position. An engagement mechanism includes a first finger, a second finger, and a plunger. The first finger and the second finger are configured to be inserted into the aperture of the portable electronic device. The plunger is positioned between the first finger and the second finger. A user input member separate from the lock mechanism and coupled to the plunger is selectively actuatable from a first position to a second position to move the plunger relative to the first and second fingers. When the cam member is in the engaged position, the user input member is precluded from moving from the first position to the second position. When the cam member is in the disengaged position, the user input member is capable of moving from the first position to the second position.

In another embodiment, the invention provides a security apparatus for a portable electronic device, the portable electronic device having an aperture. The security apparatus includes a lock mechanism including a lock cylinder and a blocking member. The lock cylinder is configured to be rotated by a key. The blocking member is coupled to the lock cylinder for rotation with the lock cylinder. The security apparatus further includes an engagement mechanism configured to be inserted into the aperture of the portable electronic device, the engagement mechanism movable between a first position, in which the engagement mechanism is configured to be secured to the portable electronic device, and a second position, in which the engagement mechanism is configured to be released from the portable electronic device. The security apparatus further includes a user input member separate from the lock mechanism configured to move the engagement member from the first position to the second position independently of movement of the blocking member by the lock cylinder.

Other aspects of the invention will become apparent by consideration of the detailed description and accompanying drawings.

### BRIEF DESCRIPTION OF THE DRAWINGS

FIG. 1 illustrates a system including a portable electronic device and a security apparatus embodying the present invention.

FIG. 2 is a perspective view of a portion of the portable electronic device, the portable electronic device having an aperture.

FIG. 3 is a front view of the portion of the portable electronic device shown in FIG. 2.

FIG. 4 is a cross-sectional view of the portion of the portable electronic device taken along section line 4-4 of FIG. 3.

FIG. 5 is a cross-sectional view of the portion of the portable electronic device taken along section line 5-5 of FIG. 3.

FIG. 6 is a perspective view of the security apparatus shown in FIG. 1.

FIG. 7 is a further perspective view of the security apparatus of FIG. 6.

FIG. 8 is a bottom view of the security apparatus of FIG. 6 with portions of a body removed to show internal components of the security apparatus.

FIG. 9 is a perspective view of an engagement mechanism of the security apparatus of FIG. 6.

FIG. 10 is a cross-sectional side view of the engagement mechanism and a lock mechanism of FIG. 6 with portions of the body removed.

FIG. 11 is a perspective view of the lock mechanism of the security apparatus of FIG. 6.

FIG. 12 is a front view of the lock mechanism in a disengaged position.

FIG. 13 is front view of the lock mechanism in an engaged position.

FIG. 14 is a side view of the lock mechanism in the disengaged position, positioned relative to a plunger of the engagement mechanism.

FIG. 15 is a side view of the lock mechanism in the engaged position, positioned relative to the plunger.

FIG. 16 is a further perspective view of the security apparatus of FIG. 6 with the engagement mechanism in a first position and the lock mechanism in the engaged position.

FIG. 17 is a perspective view of the security apparatus of FIG. 6 with the lock mechanism in the disengaged position.

FIG. 18 is a perspective view of the security apparatus of FIG. 6 with the lock mechanism in the engaged position.

FIG. 19 is a perspective view of the security apparatus of FIG. 6 with the lock mechanism in the disengaged position.

FIG. 20 is a perspective view of the security apparatus of FIG. 6 with the engagement mechanism in a second position and the lock mechanism in the disengaged position.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

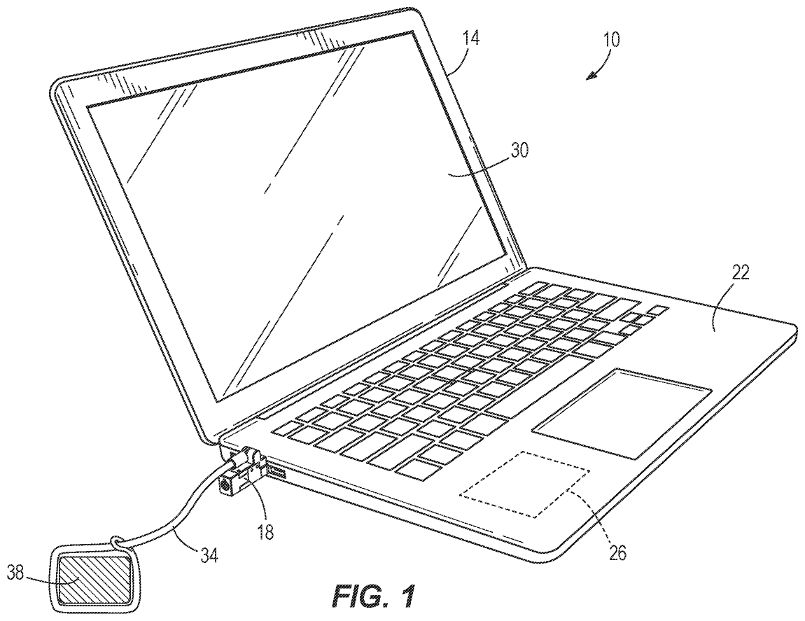

FIG. 1 illustrates a system 10 including a portable electronic device 14 and a security apparatus 18. In the illustrated embodiment, the portable electronic device 14 is a laptop computer, but may alternatively be a tablet computer, a smartphone, an eReader, an MP3 player, and the like. The illustrated portable electronic device 14 includes a housing 22, a processor 26 positioned within the housing 22, and a screen 30 supported by the housing 22. In some embodiments, the screen 30 may be a touchscreen. In other embodiments, such as the illustrated embodiment, the portable electronic device 14 may also or alternatively include other input mechanisms, such as a keyboard, keypad, or touchpad. The security apparatus 18 is connected to the portable electronic device 14 and includes a cable 34 to secure the portable electronic device 14 to an immovable object 38, such as a table, a chair, a bracket, a wall, and the like.

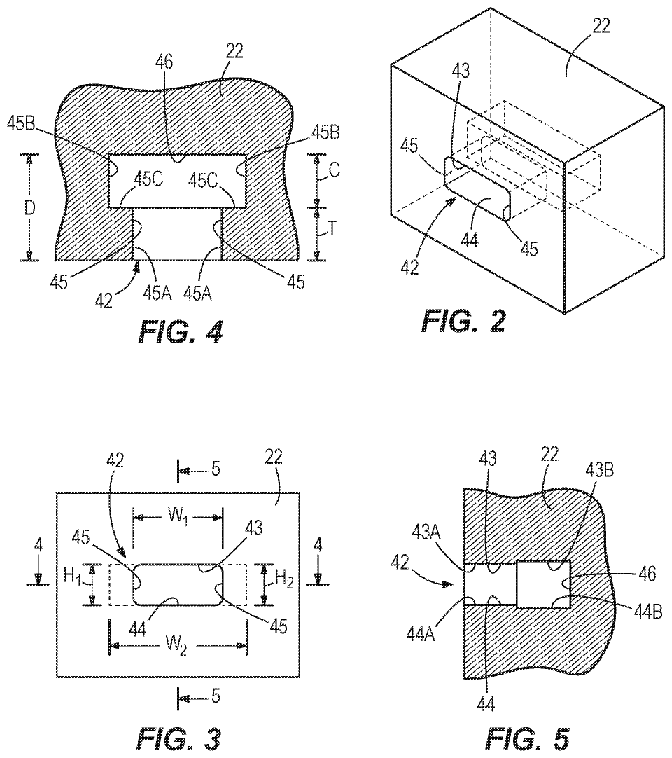

As shown in FIGS. 2-5, the portable electronic device 14 has an aperture 42, or slot, formed in the housing 22. The aperture 42 is defined by an upper wall 43, a lower wall 44, two opposing sidewalls 45, and a rear wall 46. The upper and lower walls 43, 44 are generally parallel to each other. The upper wall 43 has a first section 43A near the outer surface of the housing 22, and a second section 43B inward of the first section 43A. Similarly, the lower wall 44 has a first section 44A near the outer surface of the housing 22, and a second section 44B inward of the first section 44A. The second sections 43B, 44B may be slightly offset relative to the first sections 43A, 44A. As shown in FIG. 4, the sidewalls 45 are generally parallel to each other and perpendicular to the upper and lower walls 43, 44. Each sidewall 45 has a first section 45A near the outer surface of the housing 22, and a second section 45B inward of the first section 45A. The second sections 45B are outwardly offset from the first sections 45A such that a shoulder or ledge 45C is formed between the first and second sections 45A, 45B. The rear wall 46 extends between and connects the upper wall 43, the lower wall 44, and the sidewalls 45. The rear wall 46 may also close the back of the aperture 42 to separate the aperture 42 from the internal components of the device 14.

By way of example, the aperture 42 can have an external width W₁ (measured between the first sections 44A of the sidewalls 44) of about 6 mm. The aperture 42 can also have an external height H₁ (measured between the upper and lower walls 43A, 43B) of about 2.5 mm. In addition, the aperture 42 can have an internal width W₂ (measured between the second sections 44B of the sidewalls 44) of at least 9 mm. Further, the aperture 42 can have an internal depth D (measured from the outer surface of the housing 22 to the rear wall 46) of at least 7 mm. The internal depth D is defined by a wall thickness T (i.e., the length of the first sections 43A, 44A, 45A) and a clearance depth C (i.e., the length of the second sections 43B, 44B, 45B). In some embodiments, the wall thickness T may be 3.5 mm±0.25 mm. Additionally, the clearance depth C may be at least 3.5 mm. The aperture 42 can also have an internal height H₂ (measured between the second sections 43B, 44B of the upper and lower walls 43, 44) of at least 2.65 mm. In other embodiments, the aperture 42 can have other dimensions. The aperture 42 is configured to receive an engagement mechanism of a security apparatus, such as one of the security apparatuses described below.

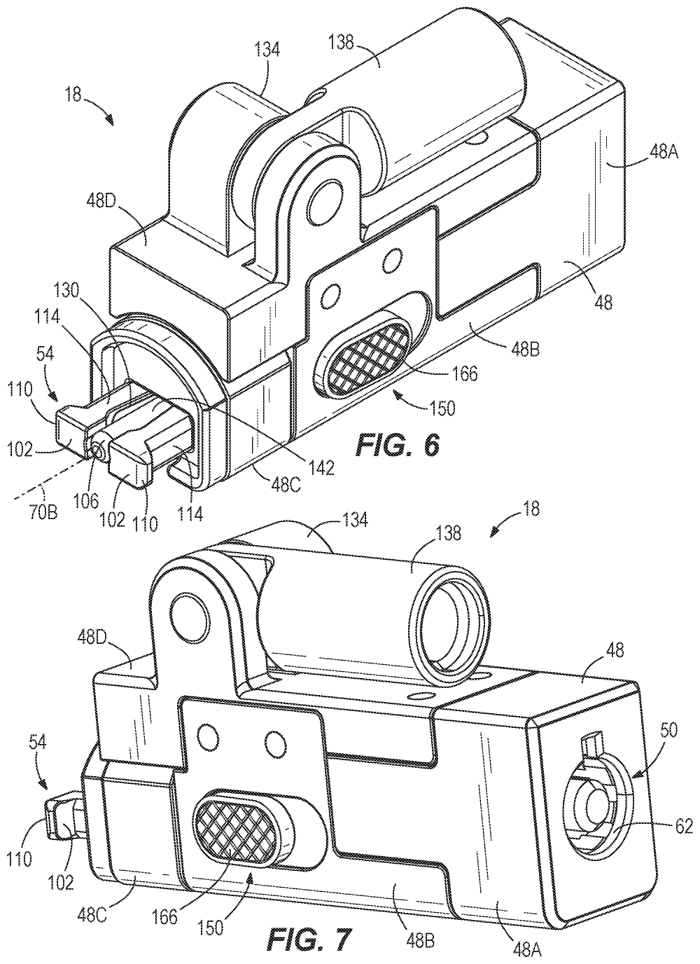

FIGS. 6-11 illustrate one example of the security apparatus 18. The security apparatus 18 includes a body 48, a lock mechanism 50, and an engagement mechanism 54. The body 48 is made of a relatively hard material, such as metal, and houses other components of the security apparatus 18. The body 48 is generally rectangular, though in other embodiments, the body 48 can have other, non-rectangular shapes.

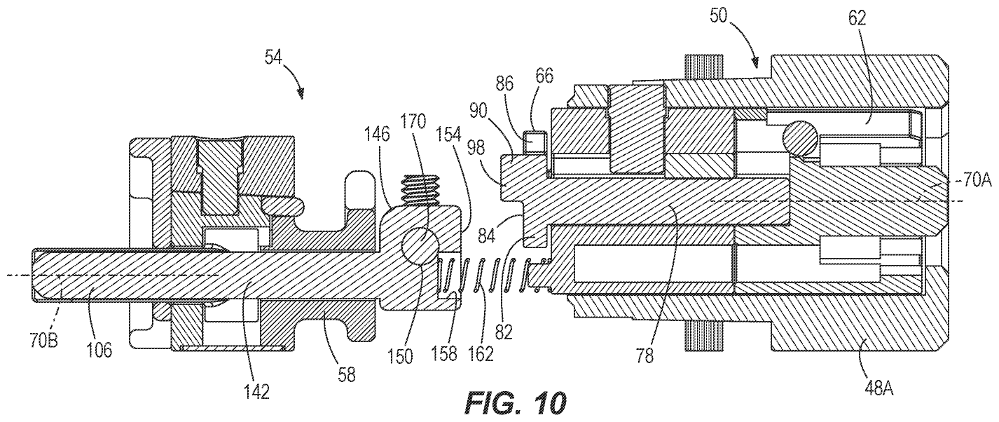

The body 48 includes a first body portion 48A that generally houses the lock mechanism 50, second and third body portions 48B, 48C that generally house the engagement mechanism 54, and a fourth body portion 48D that couples to a cable mount 134. The first, second, and fourth body portions 48A, 48B, 48D are fastened to one another with non-removable fasteners. The third body portion 48C is rotatable relative to the second body portion 48B such that the engagement mechanism 54 is rotatable relative to the first, second, and fourth body portions 48A, 48B, 48D. This rotational relationship between the third body portion 48C and the remainder of the body 48 allows the engagement mechanism 54 to interact with the aperture 42 of the portable electronic device 14 when the first, second, and fourth body portions 48A, 48B, 48D are collectively rotated to multiple different orientations. As shown in FIG. 10, the third body portion 48C includes a tubular portion 58 that extends around the plunger 106 such that the third body portion 48C is rotatable about the plunger 106.

As shown in FIGS. 6 and 7, the security apparatus 18 also includes a cable mount 134 supported by the body 48. The illustrated cable mount 134 is attached to the body 48 at a lengthwise position between the lock mechanism 50 and the engagement mechanism 54. The cable mount 134 includes a boss 138 rotatably coupled to the body 48. The cable mount 134 is configured to securely receive an end of the flexible cable 34 (FIG. 1), which can be wrapped around an immovable object 38 (FIG. 1) to secure the security apparatus 18 (and, thereby, the portable electronic device 14) to the immovable object 38.

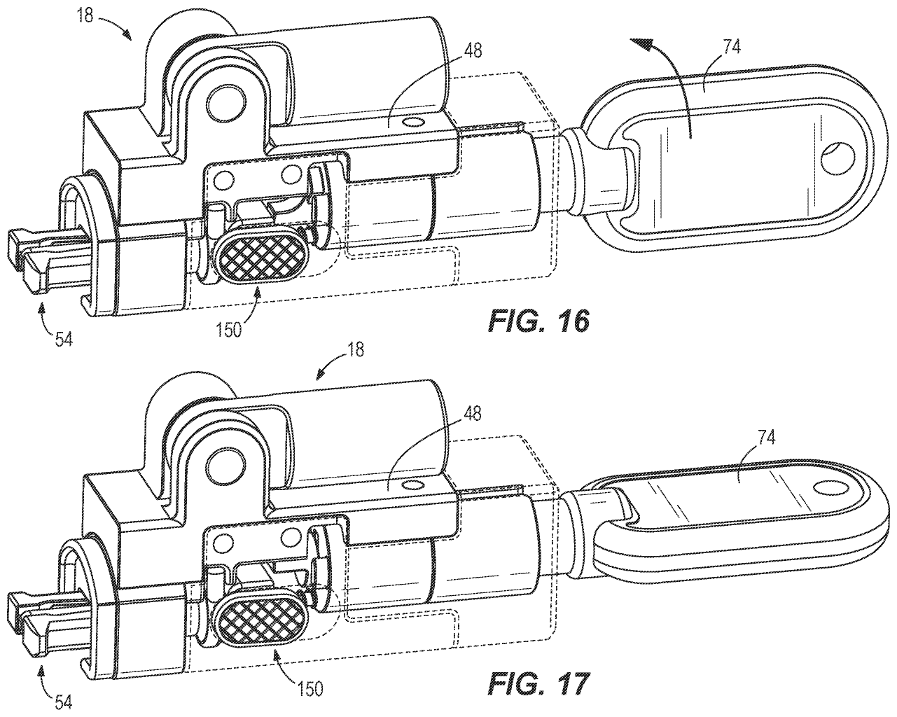

As shown in FIGS. 7 and 11-15, the illustrated lock mechanism 50 includes a lock cylinder 62 and a cam member 66. The lock cylinder 62 and the cam member 66 are positioned within the body 48. As shown in FIG. 10, the lock cylinder 62 is arranged parallel to the engagement mechanism 54 along parallel first and second longitudinal axes 70A, 70B of the security apparatus 18. In the illustrated embodiment, the lock cylinder 62 is rotatable by, for example, a key 74 (FIGS. 16-17) between an engaged position and a disengaged position.

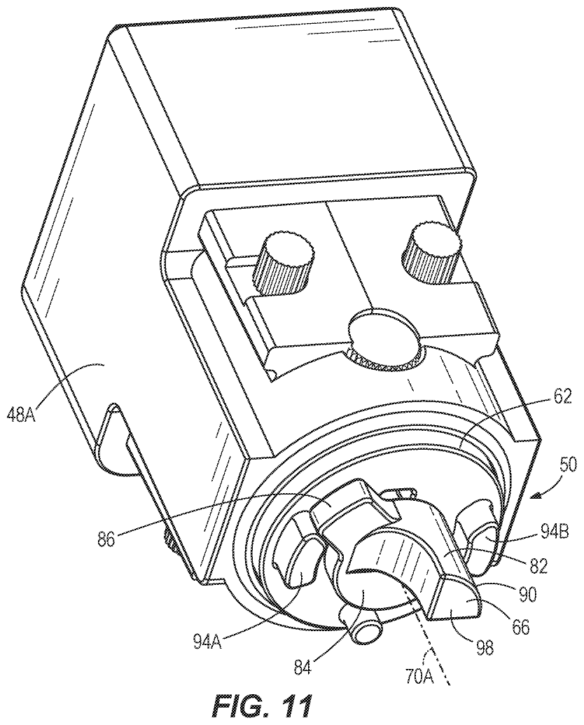

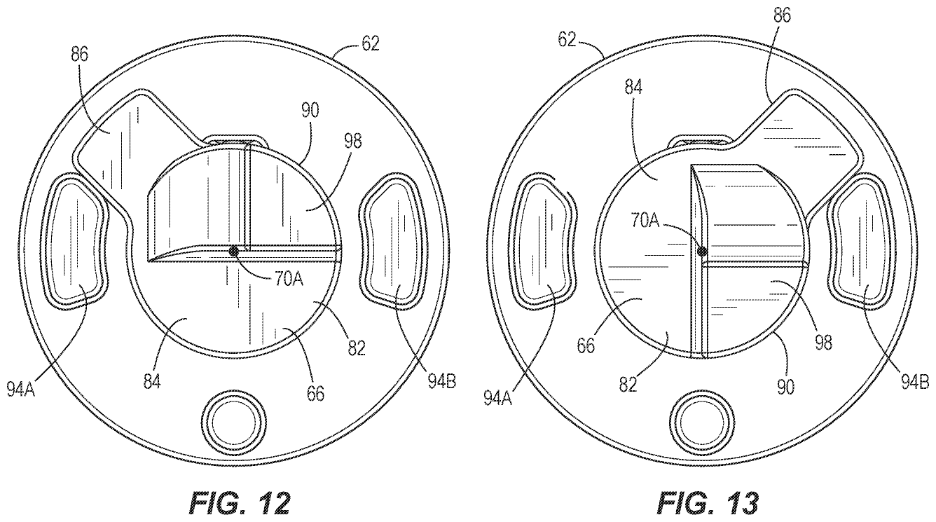

The cam member 66 is coupled to the lock cylinder 62 for rotation with the lock cylinder 62 about the first longitudinal axis 70A. As shown in detail in FIGS. 10 and 11, the cam member 66 includes a stem 78 that extends into the lock cylinder 62, and a cam body 82 positioned forward of the lock cylinder 62 for selectively engaging the engagement mechanism 54. The cam body 82 has a central portion 84 that is generally circular in cross section, and additionally includes a radial lug 86 extending radially outward from the central portion 84 and a longitudinal protrusion 90 extending longitudinally outward from the central portion 84 toward the engagement mechanism 54. The radial lug 86 selectively engages first and second rotational stops 94A, 94B that are coupled to the lock mechanism 50. When the lock mechanism 50 is in the disengaged position, as shown in FIG. 12, the radial lug 86 is positioned against the first rotational stop 94A. When the lock mechanism is rotated from the disengaged position to the engaged position, as shown in FIG. 13, the radial lug 86 is positioned against the second rotational stop 94B.

The longitudinal protrusion or blocking member 90, which extends in the longitudinal direction (parallel to the axis 70A) from the central portion 84, is radially offset from the central portion 84 such that a distal end 98 of the protrusion 90 (furthest away from the central portion 84) covers approximately a single quadrant of the central portion 84. By rotating between the disengaged position and the engaged position, as shown in FIGS. 12 and 13 respectively, the distal end 98 of the protrusion 90 rotates into different, non-overlapping positions. As described in greater detail below, in the disengaged position, the protrusion 90 is misaligned from the plunger 106 and, in the engaged position, the protrusion 90 is aligned with the plunger 106.

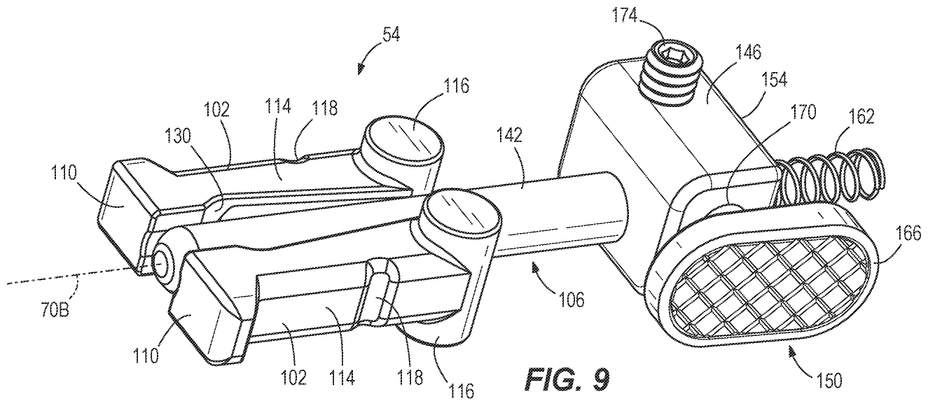

As shown in FIGS. 9 and 10, the illustrated engagement mechanism 54 includes two fingers 102 and a plunger 106. The fingers 102 are movable (e.g., pivotable) between an unlocked or retracted position and a locked or expanded position. When the fingers 102 are in the unlocked position, the engagement mechanism 54 is insertable into and removable from the aperture 42 in the portable electronic device 14 (FIGS. 1-5). When the fingers 102 are in the locked position, the engagement mechanism 54 engages the housing 22 of the portable electronic device 14 to secure the security apparatus 18 to the device 14. Each finger 102 includes an enlarged distal end 110 and a relatively narrower stem 114. The enlarged distal ends 110 facilitate engaging (e.g., contacting or “grabbing”) the housing 22 of the portable electronic device 14 so that the security apparatus 18 cannot be pulled out of the aperture 42. Particularly, the enlarged distal ends 110 engage the ledges 45C of the sidewalls 45 (FIG. 4) formed by the aperture 42. The relatively narrower stems 114 create a recessed area 130 between the fingers 102 for receiving the plunger 106. Each finger 102 also includes a boss 116 at an end of the stem 114 opposite from the enlarged distal end 110. The bosses 116 define spaced apart pivot axes for the fingers 102. The third body portion 48C coupled to the body 48 retains the fingers 102 and the plunger 106 in connection with the lock mechanism 50 and the body 48.

With continued reference to FIGS. 9 and 10, the plunger 106 is positioned between the fingers 102 to selectively move the fingers 102 from the unlocked position to the locked position. The plunger 106 is movable (e.g., slidable) along the longitudinal axis 70B of the engagement mechanism 54 to selectively actuate the fingers 102. The illustrated plunger 106 includes a cylindrical rod 142 that extends between the fingers 102, a base 146, and a user input member 150 coupled to the base 146. A first longitudinal end of the cylindrical rod 142 presses against the fingers 102 to push the fingers 102 outward. A second longitudinal end of the cylindrical rod 142 (opposite the first longitudinal end) is coupled to (e.g., fastened to, formed integrally with) the base 146. The base 146 is a generally rectangular prism having a larger cross-section than the circular cross-section of the cylindrical rod 142. As shown in FIG. 10, a rear surface 154 of the base 146 includes a cutout 158 for receiving a biasing member (e.g., a spring such as a compression spring). The biasing member 162 extends between the base 146 and the lock cylinder 62 and biases the plunger 106 forward into engagement with the fingers 102. In some embodiments, the biasing member 162 may be omitted such that the plunger 106 is not biased to any position.

In other embodiments, the engagement mechanism 54 may have other configurations. For example, in some embodiments, the engagement mechanism 54 may only include one finger and a plunger. In such embodiments, the plunger may act as the second finger that engages the housing 22 of the portable electronic device 14 when in the extended position. In other embodiments, the plunger 106 may be, for example, paddle-shaped. In such embodiments, the plunger 106 may rotate between the fingers 102 (rather than linearly slide) to push the fingers 102 apart from the unlocked position to the locked position. In still other embodiments, the engagement mechanism 54 may include a scissor-style mechanism without a plunger. In such embodiments, ends of the fingers 102 may be selectively engaged to pivot the fingers 102 toward and away from each other.

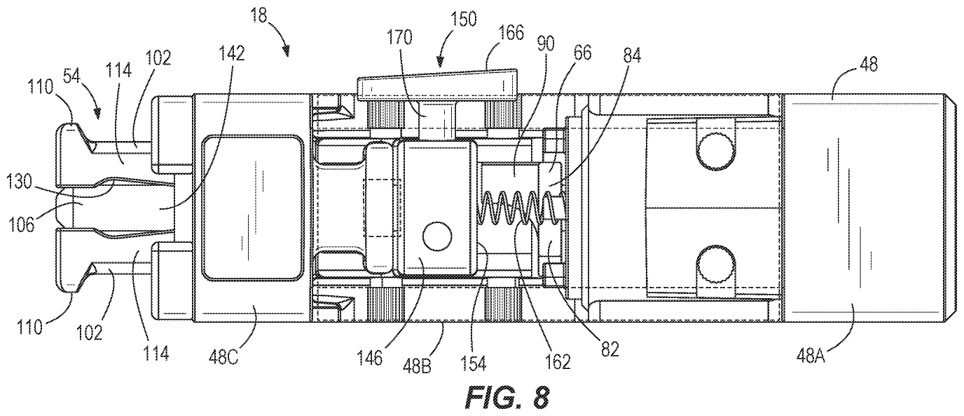

The user input member 150 is coupled to the base 146. As shown in FIGS. 8 and 9, the user input member includes a slider 166 and a stem 170. The slider 166 extends through the body 48 and is engageable by a user. The stem 170 is coupled to the slider 166 and extends into the base 146 to couple the slider 166 to the base 146. In some embodiments, a fastener 174 retains the stem 170 within the base 146. With the user input member 150 secured to the base 146 and the base 146 secured to the cylindrical rod 142, movement of the user input member 150 results in similar movement of the cylindrical rod 142 relative to the fingers 102. The biasing member 162 biases the user input member 150 to a first position, and the user input member 150 is movable (e.g., slidable) against the bias of the biasing member 162 to a second position. The user input member 150 is separate from the lock mechanism 50 and lock cylinder 62 and is operable independent from operation of the lock mechanism 50 and lock cylinder 62. In other embodiments, motion of the user input member 150 may be different from the sliding motion of the slider 166. In some embodiments, the user input member is operable via a rotational input or a depression (e.g., of a button or rocker).

As shown in FIG. 9, in the first position (i.e., when the fingers 102 are in the locked position), the cylindrical rod 142 of the plunger 106 extends outward between the fingers 102 to prevent the fingers 102 from moving inward toward one another. The plunger 106 is moved to the second position by sliding the user input member 150 against the spring bias of the biasing member 162 to the second position. In the second position (i.e., when the fingers 102 are in the unlocked position), the first distal end of the cylindrical rod 142 is received within the recessed area 130 formed between the fingers 102. The fingers 102 are moved (or movable; e.g., pivoted) toward each other so that the enlarged distal ends 110 contact each other. In some embodiments, the engagement mechanism 54 may include a spring element, such as an elastomeric ring (not shown) that may be positioned within the recesses 118 shown in FIG. 9, to help move or bias the fingers 102 toward each other when the plunger 106 is in the second position. In this position, the engagement mechanism 54 can be inserted into or removed from the aperture 42 of the portable electronic device 14.

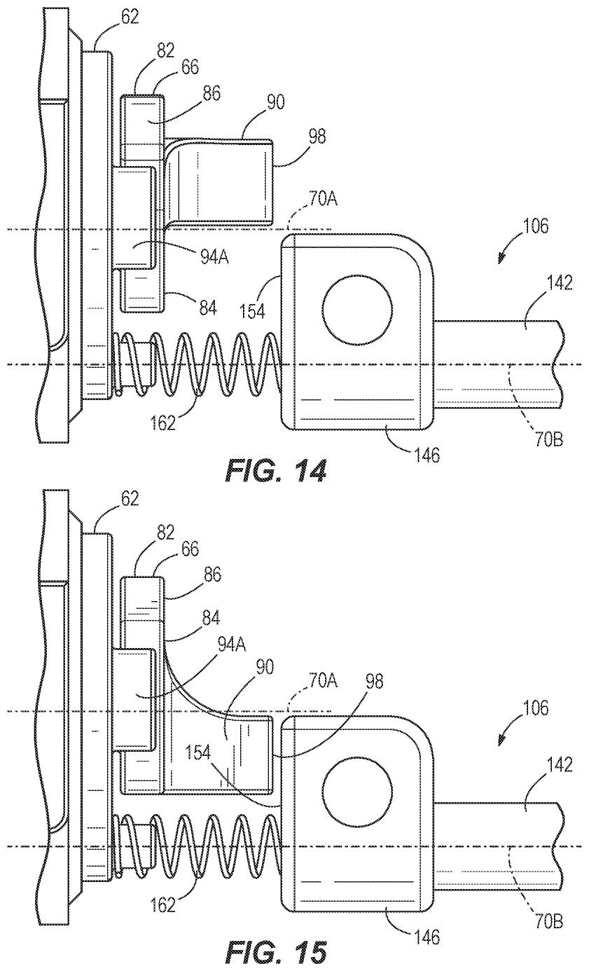

Referring to FIGS. 12-15, when the cam member 66 is rotated (e.g., by rotating the lock cylinder 62 with the key 74) from the disengaged position (FIGS. 12 and 14) to the engaged position (FIGS. 13 and 15), the protrusion 90 is rotated into a blocking position that prohibits movement of the plunger 106 from the first position to the second position. As shown in FIG. 14, in the disengaged position, the protrusion 90 is misaligned from the base 146 such that the plunger 106 can be moved rearward against the bias of the biasing member 162, avoiding contact with the protrusion 90, to the second position in which the fingers 102 disengage the aperture 42 in the electronic device 14. As shown in FIG. 15, in the engaged position, the protrusion 90 is aligned with the base 146. As such, attempting to move the plunger 106 rearwards against the spring bias towards the second position instead pushes the rear surface 154 of the base 146 into engagement and abutment with the distal end 98 of the protrusion 90. This contact precludes the plunger 106 from moving to the second position. Therefore, when the cam member 66 is in the engaged position, the user input member 150 is precluded from moving from the first position to the second position. Additionally, when the cam member 66 is in the disengaged position, the user input member 150 is capable of moving from the first position to the second position.

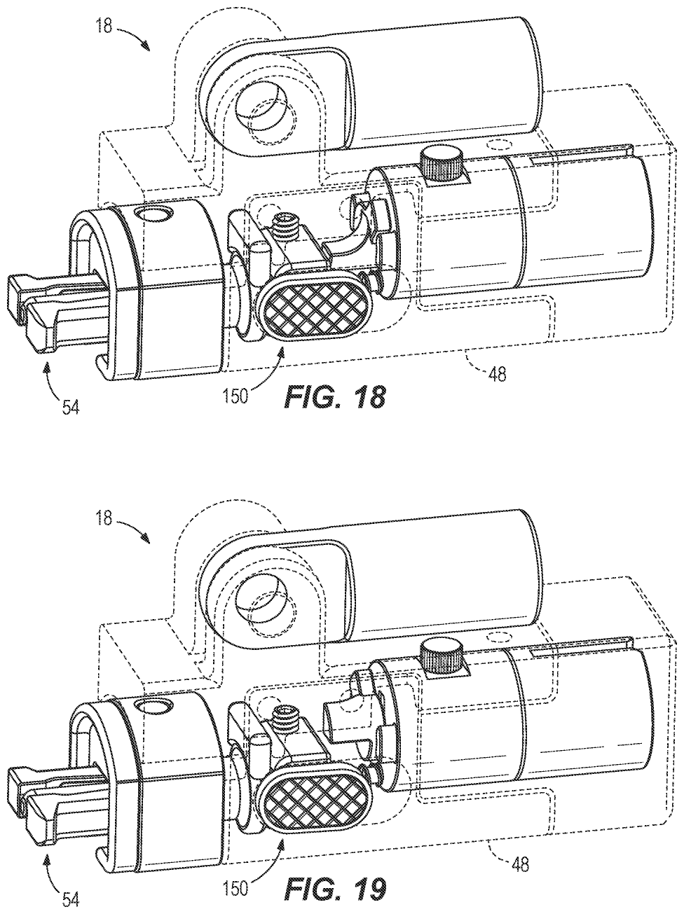

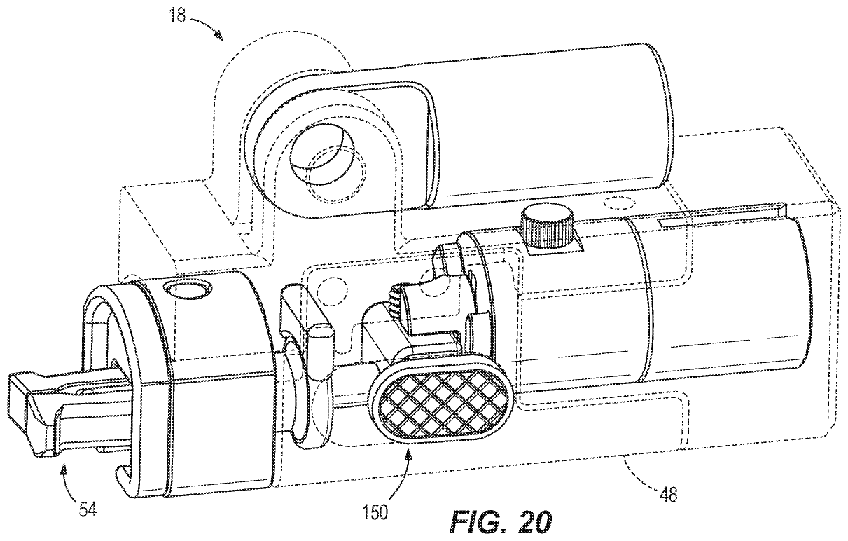

In addition to illustrating the key 74 engaging the lock cylinder 62, FIGS. 16-20 illustrate additional views of the security apparatus 18. In FIG. 16, the key 74 is in a first position corresponding to the protrusion 90 being in the engaged position. In FIG. 17, the key 74 is in a second position, rotated, for example, 90 degrees relative to the first position of the key 74 and the protrusion 90 is in the disengaged position. FIGS. 18-19 show the engaged and disengaged positions of the plunger 90. In both such positions, the input member 150 is configured to rest in the first position without user input and is biased to the first position. FIG. 20 illustrates the input member 150 repositioned (e.g., moved, slid, etc.) to the second position, movement that is permitted with the protrusion 90 rotated out of axial alignment with the plunger 106. This movement is precluded by the axial alignment of the protrusion 90 and plunger 106 when the cam member 66 is in the engaged position.

In operation, to secure the security apparatus 18 to the portable electronic device 14, the user engages the slider 166 to slide the input member 150 and plunger 106 from the first position, against the bias of the biasing member 162, to the second position. If motion of the input member 150 is precluded (or blocked) by the protrusion 90 of the cam member 66, the user precedes this step by inserting the key 74 into the lock cylinder 62 and rotating the key 74 to move the protrusion 90 from the engaged position to the disengaged position. In the second position, the plunger 106 is moved out of engagement with the fingers 102, and the fingers 102 are configured to (or biased to) move inward towards one another to fit within the aperture 14 in the electronic device 14. The user positions the fingers 102 within the aperture 14 and releases the slider 166. The biasing member 162 returns the plunger 106 and input member 150 to the first position, thereby expanding the fingers 102. In embodiments where the biasing member 162 is omitted, the user engages the slider 166 to slide the input member 150 and plunger 106 back to the first position to expand the fingers 102. In this position, the security apparatus 18 is coupled to the portable electronic device 14, but is not secured, as a user can slide the input member 150 to uncouple the security apparatus 18 from the portable electronic device 14. With the fingers 102 inserted into the aperture 42 and the plunger 106 returned to the first position, the user rotates the key 74 within the lock cylinder 62 to rotate the cam member 66 (and specifically the protrusion 90 of the cam member 66) into the engaged position. In the engaged position, the protrusion 90 precludes movement of the user input member 150 from the first position to the second position, thereby precluding movement of the plunger 106 out of engagement with the fingers 102. Rotating the cam member 66 into the engaged position thereby secures the security apparatus 18 to the portable electronic device 14.

In operation, to remove the security apparatus 18 from the portable electronic device 14, the user inserts the key 74 into the lock cylinder 62 and rotates the lock cylinder 62 and cam member 66 from the engaged position to the disengaged position. In the disengaged position, the security apparatus 18 is still coupled to the portable electronic device 14 as movement of the cam member 66 does not move the plunger 106 relative to the first and second fingers 102. By sliding the slider 166 rearward against the bias of the biasing member 162, the plunger 106 is moved from the first position to the second position, thereby allowing the fingers 102 to move towards one another into a position that can be removed from the aperture 42.

Although the invention has been described with reference to certain preferred embodiments, variations and modifications exist within the scope and spirit of the invention. Various features and advantages of the invention are set forth in the following claims.

What is claimed is:

1. A security apparatus for a portable electronic device, the portable electronic device having an aperture, the security apparatus comprising:
a lock mechanism including a lock cylinder and a cam member, the lock cylinder configured to be rotated by a key, the cam member coupled to the lock cylinder for rotation with the lock cylinder between an engaged position and a disengaged position;
an engagement mechanism including a first finger, a second finger, and a plunger, the first finger and the second finger configured to be inserted into the aperture of the portable electronic device, the plunger positioned between the first finger and the second finger; and
a user input member separate from the lock mechanism and coupled to the plunger, the user input member selectively actuatable from a first position to a second position to move the plunger relative to the first and second fingers,
wherein, when the cam member is in the engaged position, the user input member is precluded from moving from the first position to the second position, and
wherein, when the cam member is in the disengaged position, the user input member is capable of moving from the first position to the second position.

2. The security apparatus of claim 1, wherein the first finger and the second finger are pivotable relative to each other.

3. The security apparatus of claim 1, wherein the lock cylinder defines a longitudinal axis, and wherein the cam member is rotatable about the longitudinal axis.

4. The security apparatus of claim 1, wherein rotation of the lock mechanism does not move the plunger.

5. The security apparatus of claim 1, further comprising:
a body, wherein the lock cylinder and the cam member are positioned within the body; and
a cable secured to the body, wherein the cable is configured to engage an immovable object.

6. The security apparatus of claim 5, further comprising a cable mount supported by the body and positioned between the lock mechanism and the engagement mechanism, wherein the cable mount includes a boss rotatable relative to the body, and wherein an end of the cable is secured to the boss.

7. A system comprising:
a portable electronic device having a housing, a processor positioned within the housing, a screen supported by the housing, and an aperture formed in the housing; and
the security apparatus of claim 1.

8. A method of operating the security apparatus of claim 1, the method comprising:
moving the user input member and the plunger from the first position to the second position;
inserting a portion of the first and second fingers into the aperture in the electronic device;
moving the slider such that the plunger returns to the first position and expands the first and second fingers into engagement with the portable electronic device; and
rotating the cam member from the disengaged position to the engaged position to preclude movement of the plunger from the first position to the second position.

9. A security apparatus for a portable electronic device, the portable electronic device having an aperture, the security apparatus comprising:
a lock mechanism including a lock cylinder and a blocking member, the lock cylinder configured to be rotated by a key, the blocking member coupled to the lock cylinder for rotation with the lock cylinder;
an engagement mechanism configured to be inserted into the aperture of the portable electronic device, the engagement mechanism movable between a first position, in which the engagement mechanism is configured to be secured to the portable electronic device, and a second position, in which the engagement mechanism is configured to be released from the portable electronic device; and
a user input member separate from the lock mechanism configured to move the engagement member from the first position to the second position independently of movement of the blocking member by the lock cylinder.

10. The security apparatus of claim 9, wherein the engagement mechanism includes a plunger, wherein, in the first position, the plunger is extended away from the lock mechanism, and wherein, in the second position, the plunger is retracted toward the lock mechanism.

11. The security apparatus of claim 10, wherein the plunger is biased to the first position by a biasing member.

12. The security apparatus of claim 11, wherein the user input member is coupled to the plunger such that the user input member is biased by the biasing member, and wherein the user input member is selectively movable against the bias of the biasing member to move the plunger to the second position.

13. The security apparatus of claim 10, wherein the blocking member is movable between a disengaged position and an engaged position, wherein, in the disengaged position, the user input member is movable against the bias of the biasing member to move the engagement mechanism to the second position, and wherein, in the engaged position, the user input member is precluded from moving the engagement mechanism to the second position.

14. The security apparatus of claim 13, wherein, in the disengaged position, the blocking member is offset from the engagement mechanism such that the engagement mechanism is to movable between the first and second positions without engaging the blocking member, and wherein, in the engaged position, the blocking member is aligned with the engagement mechanism such that the blocking member precludes the engagement mechanism from moving to the second position.

15. The security apparatus of claim 10, wherein the user input member includes a slider configured to translate with the engagement mechanism between the first and second positions.

16. The security apparatus of claim 9, wherein the lock cylinder defines a longitudinal axis, and wherein the blocking member is rotatable about the longitudinal axis.

17. The security apparatus of claim 9, further comprising:
a body, wherein the lock cylinder and the blocking member are positioned within the body; and
a cable secured to the body, wherein the cable is configured to engage an immovable object.

18. The security apparatus of claim 17, further comprising a cable mount supported by the body and positioned between the lock mechanism and the engagement mechanism, wherein the cable mount includes a boss rotatable relative to the body, and wherein an end of the cable is secured to the boss.

19. A system comprising:
a portable electronic device having a housing, a processor positioned within the housing, a screen supported by the housing, and an aperture formed in the housing; and
the security apparatus of claim 9.

20. A method of operating the security apparatus of claim 9, the method comprising:
actuating the user input member to move the engagement mechanism from the first position to the second position;
inserting a portion of the engagement mechanism into the aperture in the portable electronic device;
returning the engagement mechanism to the first position while the portion of the engagement mechanism is inserted into the aperture of the portable electronic device; and
rotating the blocking member via the lock cylinder to preclude movement of the engagement mechanism from the first position to the second position.
